(19) United States
(12) Patent Application Publication
(10) Pub. No.: US 2026/0142780 A1
(43) Pub. Date: May 21, 2026

(54) DEMODULATION REFERENCE SIGNAL CONFIGURATIONS

(71) Applicant: Apple Inc., Cupertino, CA (US)

(72) Inventors: Haitong Sun, Saratoga, CA (US); Ankit Bhamri, Bad Nauheim (DE); Chunxuan Ye, San Diego, CA (US); Dawei Zhang, Saratoga, CA (US); Hong He, San Jose, CA (US); Huaning Niu, San Jose, CA (US); Seyed Ali Akbar Fakoorian, San Diego, CA (US); Wei Zeng, Saratoga, CA (US)

(21) Appl. No.: 19/121,264

(22) PCT Filed: Nov. 3, 2023
(86) PCT No.: PCT/US2023/078693

§ 371 Date: Apr. 15, 2025

Related U.S. Application Data
(60) Provisional application No. 63/422,895, filed on Nov. 4, 2022.

(51) Int. Cl. H04L 5/00; H04J 13/00

(52) U.S. Cl. CPC H04L 5/0051; H04J 13/004; H04L 5/0016

(57) ABSTRACT

Disclosed are methods, systems, and computer-readable medium to perform operations including: generating a mapping pattern that comprises a length-4 frequency division orthogonal cover code (FD-OCC4), the mapping pattern for mapping demodulation reference signals (DMRS) in frequency to a plurality of resource elements in at least one orthogonal frequency-division multiplexing (OFDM) symbol, wherein the DMRS are associated with a plurality of DMRS ports; mapping, using the FD-OCC4, the DMRS to the plurality of resource elements in the at least one OFDM symbol; and transmitting a transmission comprising the at least one OFDM symbol.

### CROSS-REFERENCE TO RELATED APPLICATIONS

The present application claims priority to U.S. Prov. App. No. 63/422,895, filed on Nov. 4, 2022, entitled “DEMODULATION REFERENCE SIGNAL CONFIGURATIONS,” which is incorporated herein by reference in its entirety.

### TECHNICAL FIELD

This disclosure relates to methods and systems for demodulation reference signal (DMRS) configurations.

### BACKGROUND

Wireless communication networks provide integrated communication platforms and telecommunication services to wireless user devices, sometimes called user equipment (UE). Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### BRIEF DESCRIPTION OF THE FIGURES

FIG. 1A and FIG. 1B illustrate an existing DMRS configuration for Type-1 DMRS.

FIG. 1C and FIG. 1D illustrate an existing DMRS configuration for Type-2 DMRS.

FIG. 2 illustrates a wireless network, in accordance with some embodiments.

FIGS. 3A. 3B, 3C illustrate a first enhanced DMRS configuration for Type-1 DMRS, according to some implementations.

FIG. 4 illustrates a table for DMRS port to DMRS pattern mapping for Type-1 DMRS, according to some implementations.

FIGS. 5A, 5B illustrate a second enhanced DMRS configuration for Type-2 DMRS, according to some implementations.

FIG. 6 illustrates a table 600 for DMRS port to DMRS pattern mapping for Type-2 DMRS, according to some implementations.

FIGS. 7A, 7B, 7C illustrate a third enhanced DMRS configuration for Type-1 DMRS, according to some implementations.

FIG. 8 illustrates another table for DMRS port to DMRS pattern mapping for Type-1 DMRS, according to some implementations.

FIG. 9 illustrates a flowchart of an example method, according to some implementations.

FIG. 10 illustrates a user equipment (UE), according to some implementations.

FIG. 11 illustrates an access node, according to some implementations.

### DETAILED DESCRIPTION

Demodulation Reference Signals (DMRS) are used in wireless communication networks to determine the quality of downlink and uplink channels. For example, DMRS can be transmitted in the uplink (UL) with a Physical Uplink Shared Channel (PUSCH). The DMRS and the PUSCH undergo the same transmission conditions (e.g., the DMRS and the PUSCH are transmitted using the same precoding and antenna ports). A base station receiving the PUSCH and the DMRS knows the sequence transmitted by the DMRS. The base station uses this information and the received DMRS to determine uplink transmission conditions.

Currently, wireless communication systems support two types of demodulation reference signals (DMRS): Type-1 DMRS and Type-2 DMRS. Generally, Type-1 DMRS uses a higher density of resource elements in the symbols allocated to DMRS than Type-2 DMRS. For example, Type-1 DMRS can use 50% of the resource elements within the symbols allocated to DMRS, and Type-2 DMRS can use 33%. For uplink DMRS, the DMRS type that the UE uses can be configured by a high-layer parameter, e.g., DMRS-UplinkConfig, received from a base station. And for downlink DMRS, the UE determines the DMRS type used based on a high-layer parameter, e.g., dmrs-Type, received from a base station.

In line with the discussion above, wireless communication systems support two types of demodulation reference signals (DMRS): Type-1 DMRS and Type-2 DMRS. In order to transmit DMRS, the wireless systems use a mapping pattern to map DMRS ports to the resource elements of one or more orthogonal frequency-division multiple access symbol (OFDM) symbols. Then, the DMRS from each DMRS port is transmitted on the resource elements to which the associated DMRS port is mapped. In this disclosure, the mapping pattern is also referred to as a DMRS configuration. In existing wireless systems, the DMRS configuration for Type-1 DMRS uses a length-2 frequency domain orthogonal cover code (FD-OCC2) and two code division multiplexing (CDM) groups to map up to four DMRS ports to one symbol. The DMRS configuration for Type-2 DMRS uses FD-OCC2 and three CDM groups to map up to six DMRS ports to one symbol.

Both DMRS configurations can be extended to two symbols using a length-2 time domain OCC (TD-OCC2). Doing so doubles the number of DMRS ports that can be mapped. Accordingly, Type-1 DMRS supports up to four DMRS ports in one symbol and up to eight DMRS ports in two symbols. Type-2 DMRS supports up to six DMRS ports in one symbol, and up to twelve DMRS ports in two symbols. Supporting multiple DMRS ports allows a single user equipment (UE) to transmit or receive DMRS on multiple transmission layers, e.g., using single user multiple-input multiple-output (SU-MIMO). Additionally, supporting multiple DMRS ports allows multiple UEs to transmit or receive DMRS using the same resources, e.g., using multi-user MIMO (MU-MIMO).

These existing DMRS configurations are described in Release 15/16/17 of the technical specifications (TSs) promulgated by the Third Generation Partnership Project (3GPP). For example, equations for mapping DMRS in the uplink (UL) are described in 3GPP TS 38.211, Version 16.7.0, Section 6.4.1.1, which is incorporated herein by reference. And the equation for mapping DMRS in the downlink (DL) is described in 3GPP TS 38.211, Version 16.7.0, Section 7.4.1.1. These equations are also provided in this disclosure.

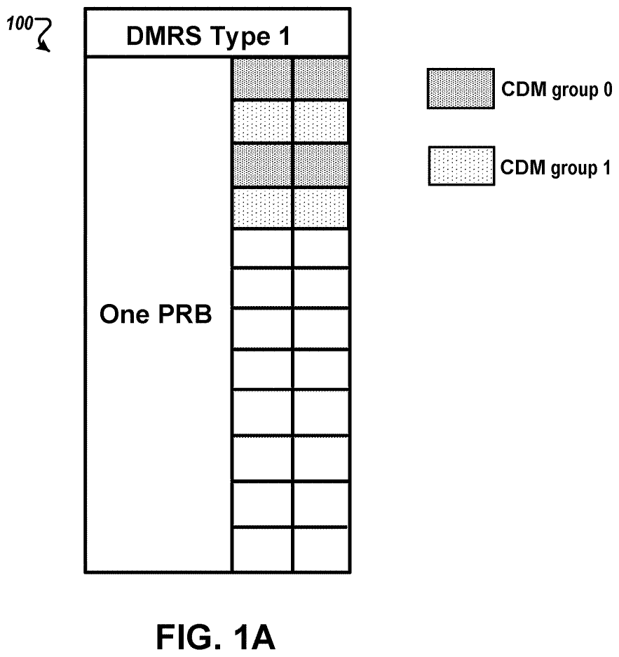

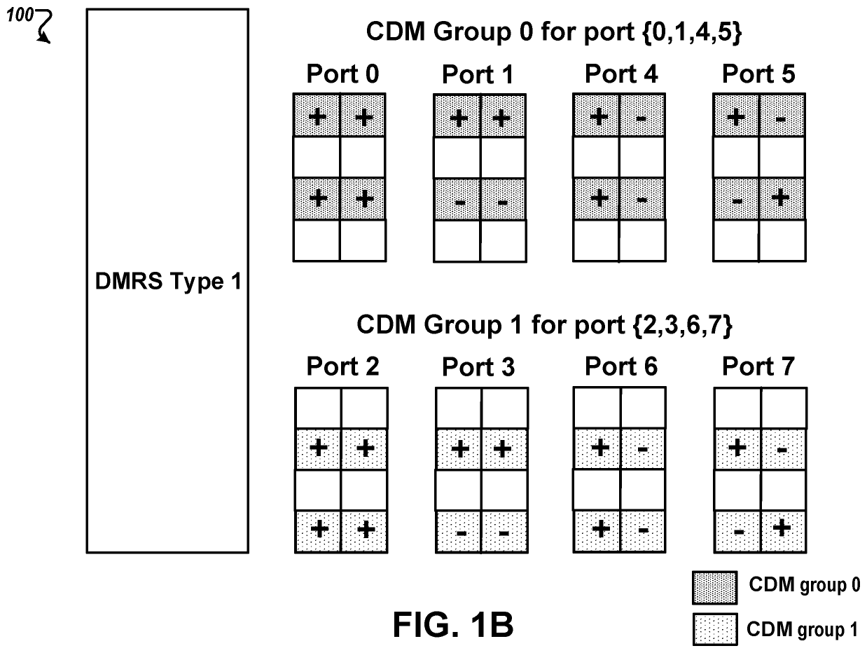

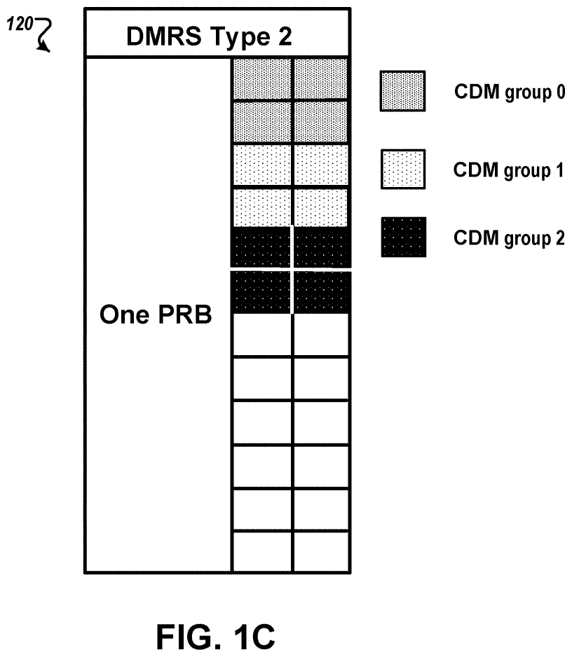

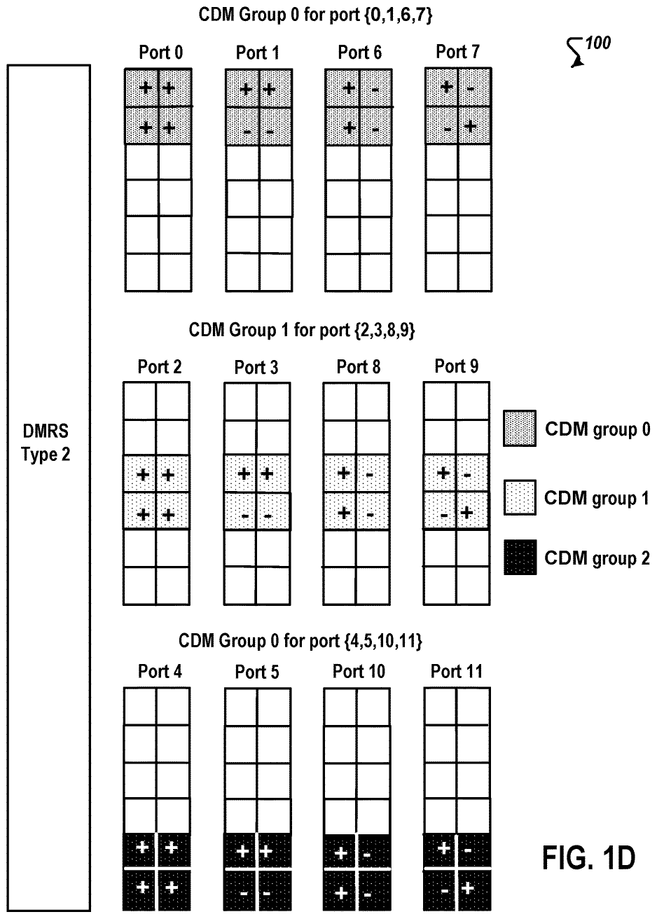

FIG. 1A and FIG. 1B illustrate an existing DMRS configuration for Type-1 DMRS. Specifically, FIG. 1A illustrates an example pattern 100 of a Type-1 DMRS mapped to resource elements in two symbols. In existing systems, the number of resource elements (also called subcarriers) in one resource block is twelve. Therefore, in this example, the number of resource elements available for DMRS in the two symbols is twenty-four resource elements.

As shown in FIG. 1A, the pattern 100 maps two CDM groups to the resource elements allocated for DMRS. Specifically, each CDM group use two resource elements in the frequency domain and two symbols in the time domain. The pattern 100 can be repeated across other resource elements of the same two symbols. For example, because the pattern 100 uses four resource elements in each symbol, the pattern can be repeated two more times in the two symbols.

FIG. 1B illustrates the mapping pattern 100 in more detail. As shown in FIG. 1B, up to eight DMRS ports can be mapped using the pattern 100. To do so, the pattern 100 uses FD-OCC2 and TD-OCC2 in each CDM group to map up to four DMRS ports across resource elements allocated for that group. In FIG. 1B, the “+” and “−” in each resource element represent the sign of the Hadamard code used for that resource element.

FIG. 1C and FIG. 1D illustrate an existing DMRS configuration for Type-2 DMRS. Specifically, FIG. 1C illustrates an example pattern 120 of a Type-2 DMRS mapped to resource elements in two symbols. As shown in FIG. 1C, the pattern 120 maps three CDM groups across the resource elements allocated for DMRS in two symbols. The pattern 120 can be repeated across other resource elements of the same two symbols. For example, because the pattern 120 uses six resource elements in each symbol, the pattern can be repeated one more time in the two symbols. FIG. 1D illustrates the mapping pattern 120 in more detail. As shown in FIG. 1D, up to twelve DMRS ports can be mapped using the pattern 120. To do so, the pattern 120 uses FD-OCC2 and TD-OCC2 in each CDM group to map up to four DMRS ports across resource elements allocated for that group. Like in FIG. 1B, the “+” and “−” in each resource element represent the sign of the Hadamard code used for that resource element.

For Release 18 of the 3GPP standards, 3GPP has agreed to specify a DMRS enhancement for Cyclic-Prefix OFDM (CP-OFDM) that increases the number of supported DMRS ports without increasing the DMRS overhead. It was further agreed that there should be a common design between DL and UL DMRS. The DMRS configurations that achieve this DMRS enhancement have not yet been specified by 3GPP.

This disclosure describes methods and systems for implementing DMRS enhancements that increase the number of supported DMRS ports in uplink and downlink DMRS, without increasing the overhead of DMRS (e.g., by reducing the frequency domain density of each DMRS port). The DMRS enhancements include enhanced DMRS configurations for Type-1 and Type-2 DMRS. Among other benefits, the enhanced DMRS configurations can at least double the number of DMRS ports that are supported by existing configurations. As an example, the enhanced DMRS configurations support up to sixteen DMRS ports for Type-1 DMRS and up to twenty-four DMRS ports for Type-2 DMRS.

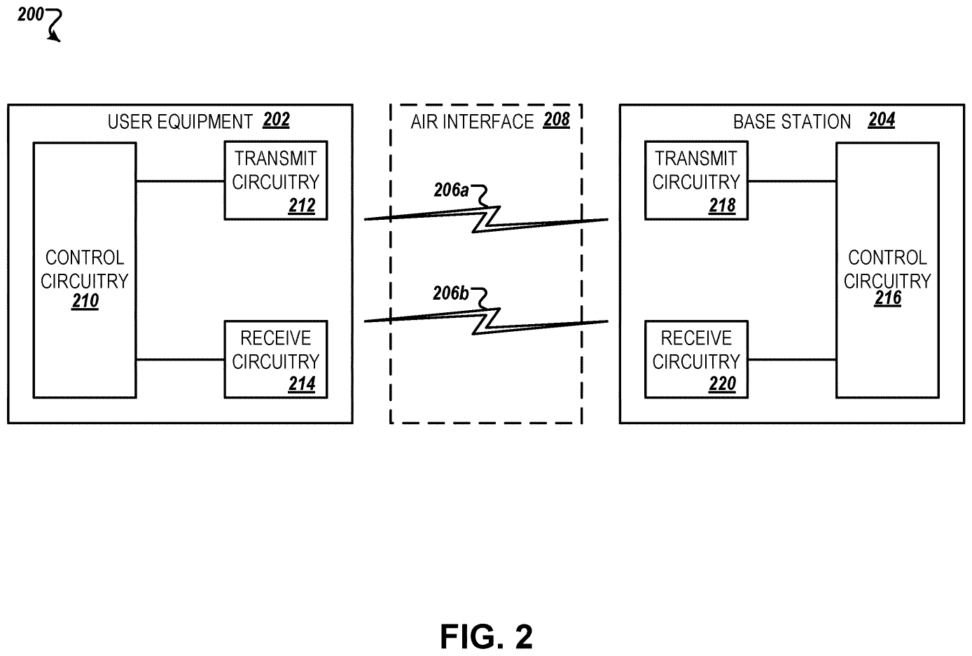

FIG. 2 illustrates a wireless network 200, in accordance with some embodiments. The wireless network 200 includes a UE 202 and a base station 204 connected via one or more channels 206A, 206B across an air interface 208. The UE 202 and base station 204 communicate using a system that supports controls for managing the access of the UE 202 to a network via the base station 204.

In some implementations, the wireless network 200 may be a Standalone (SA) network that incorporates Fifth Generation (5G) New Radio (NR) communication standards as defined by the Third Generation Partnership Project (3GPP) technical specifications. In some implementations, the wireless network 200 may be a Non-Standalone (NSA) network that also incorporates Long Term Evolution (LTE). For example, the wireless network 200 may be a E-UTRA (Evolved Universal Terrestrial Radio Access)-NR Dual Connectivity (EN-DC) network, or a NR-EUTRA Dual Connectivity (NE-DC) network. Furthermore, other types of communication standards are possible, including future 3GPP systems (e.g., Sixth Generation (6G)) systems, Institute of Electrical and Electronics Engineers (IEEE) 802.11 technology, or the like. While aspects may be described herein using terminology commonly associated with 5G NR, aspects of the present disclosure can be applied to other systems, such as 4G and/or systems subsequent to 5G (e.g., 6G).

In the wireless network 200, the UE 202 and any other UE in the system may be, for example, laptop computers, smartphones, tablet computers, machine-type devices such as smart meters or specialized devices for healthcare, intelligent transportation systems, or any other wireless devices with or without a user interface. In network 200, the base station 204 provides the UE 202 network connectivity to a broader network (not shown). This UE 202 connectivity is provided via the air interface 208 in a base station service area provided by the base station 204. In some implementations, such a broader network may be a wide area network operated by a cellular network provider, or may be the Internet. Each base station service area associated with the base station 204 is supported by antennas integrated with the base station 204. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 202 includes control circuitry 210 coupled with transmit circuitry 212 and receive circuitry 214. The transmit circuitry 212 and receive circuitry 214 may each be coupled with one or more antennas. The control circuitry 210 may include various combinations of application-specific circuitry and baseband circuitry. The transmit circuitry 212 and receive circuitry 214 may be adapted to transmit and receive data, respectively, and may include radio frequency (RF) circuitry or front-end module (FEM) circuitry.

In various implementations, aspects of the transmit circuitry 212, receive circuitry 214, and control circuitry 210 may be integrated in various ways to implement the operations described herein. The control circuitry 210 may be adapted or configured to perform various operations such as those described elsewhere in this disclosure related to a UE.

The transmit circuitry 212 can perform various operations described in this specification. Additionally, the transmit circuitry 212 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 212 may be configured to receive block data from the control circuitry 210 for transmission across the air interface 208.

The receive circuitry 214 can perform various operations described in this specification. Additionally, the receive circuitry 214 may receive a plurality of multiplexed downlink physical channels from the air interface 208 and relay the physical channels to the control circuitry 210. The plurality of downlink physical channels may be multiplexed according to TDM or FDM along with carrier aggregation. The transmit circuitry 212 and the receive circuitry 214 may transmit and receive both control data and content data (e.g., messages, images, video, etc.) structured within data blocks that are carried by the physical channels.

FIG. 2 also illustrates the base station 204. In implementations, the base station 204 may be an NG radio access network (RAN) or a 5G RAN, an E-UTRAN, a non-terrestrial cell, or a legacy RAN, such as a UTRAN. As used herein, the term “NG RAN” or the like may refer to the base station 204 that operates in an NR or 5G wireless network 200, and the term “E-UTRAN” or the like may refer to a base station 204 that operates in an LTE or 4G wireless network 200. The UE 202 utilizes connections (or channels) 206A, 206B, each of which includes a physical communications interface or layer.

The base station 204 circuitry may include control circuitry 216 coupled with transmit circuitry 218 and receive circuitry 220. The transmit circuitry 218 and receive circuitry 220 may each be coupled with one or more antennas that may be used to enable communications via the air interface 208. The transmit circuitry 218 and receive circuitry 220 may be adapted to transmit and receive data, respectively, to any UE connected to the base station 204. The transmit circuitry 218 may transmit downlink physical channels includes of a plurality of downlink subframes. The receive circuitry 220 may receive a plurality of uplink physical channels from various UEs, including the UE 202.

In FIG. 2, the one or more channels 206A, 206B are illustrated as an air interface to enable communicative coupling, and can be consistent with cellular communications protocols, such as a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 202 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

In some implementations, a transmitting device, e.g., the UE 202 or the base station 204, is configured to implement one or more enhanced DMRS configurations. The following description describes the UE 202 as the transmitting device; however, the same principles apply to the base station 204 as the transmitting device. Thus, the enhanced DMRS configurations can be applied to both UL and DL DMRS. The transmitting device can be preconfigured to select one of the enhanced DMRS configurations (e.g., based on 3GPP standards) or may receive signaling indicating the enhanced DMRS configuration to use (e.g., the UE receives higher layer signaling from the base station). As described in more detail below, the enhanced DRMS configurations can at least double the number of DMRS ports supported by existing configurations.

In some implementations, the UE 202 is configured to use a first enhanced DMRS configuration for Type-1 DMRS. The enhanced configuration uses length-4 FD-OCC (FD-OCC4) and two CDM groups to map DMRS ports to the resource elements of one or more symbols allocated for DMRS. The enhanced configuration supports up to eight DMRS ports in one symbol, and up to sixteen DMRS ports in two symbols. TD-OCC2 can be used to extend the enhanced configuration from one symbol to two symbols.

In some implementations, the UE 202 may be configured with one or more options for the first enhanced DMRS configuration. In a first option, each CDM group is allocated every second resource element in a symbol. This allocation creates a “comb” where resource elements belonging to the same CDM group are not adjacent in frequency. In a second option, each CDM group is allocated two sets of two resource elements that are adjacent in frequency. In this option, each pair of resource elements belonging to the same CDM group are separated by a pair of resource elements belonging to the other CDM group. In a third option, each CDM group is allocated a set of resource elements that are consecutive in frequency.

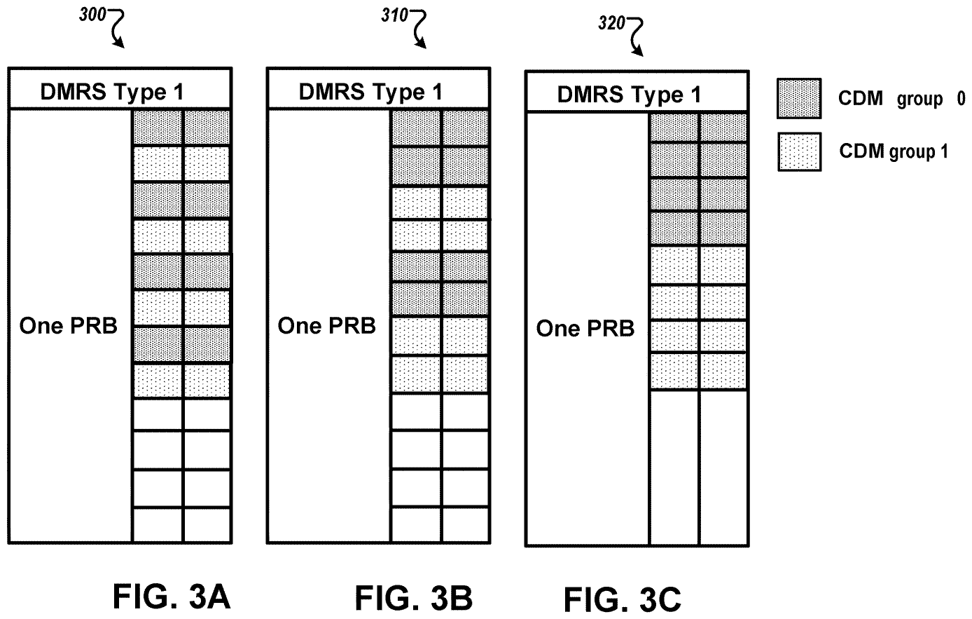

FIGS. 3A. 3B, 3C illustrate the first enhanced DMRS configuration for Type-1 DMRS, according to some implementations. In these figures, the first enhanced DMRS configuration uses FD-OCC4, two CDM groups, and TD-OCC2 to map DMRS ports to two symbols. Because the DMRS ports are mapped to two symbols, the enhanced DMRS configuration supports up to sixteen DMRS ports. As shown in the figures, however, there are different mapping pattern options. Each figure illustrates a different option.

FIG. 3A illustrates a first option 300 of the first enhanced DMRS configuration. As shown in FIG. 3A, each CDM group is allocated every second resource element in a symbol. This creates a “comb” where resource elements belonging to the same CDM group are not adjacent in frequency. Thus, as shown in FIG. 3A, in each symbol, a first resource element is allocated to CDM group 0, a second resource element is allocated to CDM group 1, a third resource element is allocated to CDM group 0, and so on. One of the advantages of this option is that it improves back-forward compatibility with legacy configurations (e.g., shown in FIG. 1A). This enables co-scheduling of a UE using the legacy configuration and another UE using the enhanced configuration on the same radio frequency resources.

FIG. 3B illustrates a second option 310 of the first enhanced DMRS configuration. As shown in FIG. 3B, in each symbol, each CDM group is allocated two sets of two resource elements that are adjacent in frequency. In this option, each pair of resource elements belonging to the same CDM group are separated by a pair of resource elements belonging to the other CDM group. As shown in FIG. 3B, in each symbol, a first pair of resource elements are allocated to CDM group 0, and a second pair of resource elements, adjacent in frequency to the first pair, are allocated to CDM group 1. Further, a third pair of resource elements, adjacent in frequency to the second pair, are allocated to CDM group 0, and a fourth pair of resource elements, adjacent in frequency to the third pair, are allocated to CDM group 1.

FIG. 3C illustrates a third option 320 of the first enhanced DMRS configuration. In this option, the resource elements belonging to each CDM group are arranged consecutively in frequency. As shown in FIG. 3C, in each symbol, the resource elements for CDM group 0 are allocated to a first set of consecutive resource elements, and the resource elements for CDM group 1 are allocated to a second set of consecutive resource elements arranged in frequency after the first set. Note that options two and three are more robust to a frequency selective fading channel, with the third option being the most robust to a frequency selective fading channel, e.g., a channel with large delay spread.

In some implementations, the UE 202 is configured to use an equation to map a DMRS sequence to resource elements of one or more symbols. As stated previously, TS 38.211 describes equations for mapping uplink/downlink DMRS to resource elements. These equations include Equation [1], Equation [2], and Equation [3] reproduced below. Equations [1], [2] are used for uplink DMRS and Equation [3] is used for downlink DMRS.

$${a}_{k , l}^{{p}_{j} , u} = {w}_{f} ( {k}^{′} ) {w}_{l} ( {l}^{′} ) r ( 2 n + {k}^{′} ) \qquad [ 1 ]$$

$${a}_{k , l}^{p , u} = {w}_{f} ( {k}^{′} ) {w}_{l} ( {l}^{′} ) r ( 2 n + {k}^{′} ) \qquad [ 2 ]$$

$${a}_{k , l}^{p , u} = {β}_{PDSCG}^{DMRS} {w}_{f} ( {k}^{′} ) {w}_{l} ( {l}^{′} ) r ( 2 n + {k}^{′} ) \qquad [ 3 ]$$

### In Equations [1], [2], [3]

$${β}_{PDSCG}^{DMRS}$$

is a transmission power factor, k represents a subcarrier index, l represents a symbol index, p represents a DMRS port index, u represents a subcarrier spacing, w_l represents a time domain (TD) sequence, i.e., TD-OCC, w_f represents a frequency domain (FD) sequence, i.e., FD-OCC, and r represents a base DMRS sequence. Note that, as described in TS 38.211, the value of “k” depends on a variable “delta”. Some of these variables are described in more detail:
\delta: the distance in unit of number of REs for the corresponding CDM group to the first CDM group;
W_{f}(k′): W_{f} represents a FD-OCC sequence. Specifically, it represents the FD-OCC code entry applied (multiplied) on the k′ RE in the frequency domain in the corresponding CDM group;
Wₜ(l′): Wₜ represents a TD-OCC sequence. Specifically, it represents the TD-OCC code entry applied (multiplied) on the l′ RE in the time domain in the corresponding CDM group.

In some implementations, the UE 202 is configured to apply the first enhanced DMRS configuration for Type-1 DMRS by selecting certain values for these variables to be used in Equations [1], [2], [3].

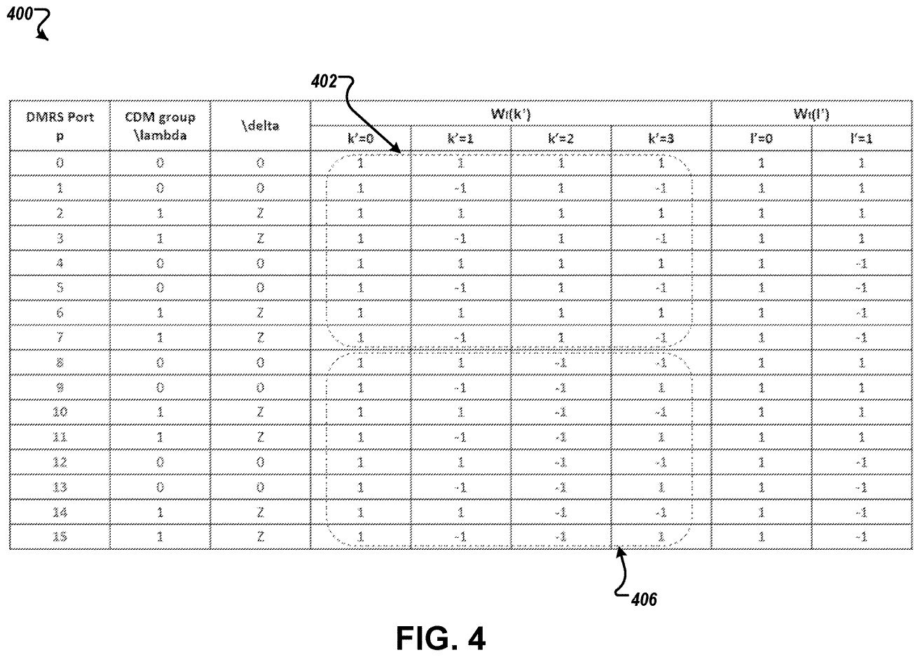

FIG. 4 illustrates a table 400 for DMRS port to DMRS pattern mapping for Type-1 DMRS, according to some implementations. The table 400 specifies the values of the variables \lambda, \delta, W_{f}(k′), Wₜ(l′) to use for mapping up to sixteen DMRS ports to two symbols. The values of the variables can be used in the equations specified in TS 38.211, e.g., Equations [1], [2], [3]. The different options for the first enhanced DMRS configuration can be achieved by selecting different values of \delta. In particular, in table 400, Z=1 for option 1, Z=2 for option 2, Z=4 for option 3.

In some implementations, the FD-OCC4 in table 400 can be generated based on an FD-OCC2 used in existing DMRS configurations. The existing FD-OCC2 for Type-1 DMRS is shown in Table 1:

TABLE 1

W_{f}(k′)

| DMRS Port | k′ = 0 | k′ = 1 |
|---|---|---|
| 0 | 1 | 1 |
| 1 | 1 | −1 |
| 2 | 1 | 1 |
| 3 | 1 | −1 |
| 4 | 1 | 1 |
| 5 | 1 | −1 |
| 6 | 1 | 1 |
| 7 | 1 | −1 |

In an example, to generate the FD-OCC4 in table 400, the values in Table 1 are first multiplied by the matrix {1,1}. This multiplication results in the FD-OCC4 values encompassed by bordering box 402 (i.e., the kronecker product of the two matrices). These FD-OCC4 values correspond to the first set of eight DMRS ports in table 400 (i.e., ports 0-7). Then, the values in Table 1 are multiplied by the matrix {1,−1}. This multiplication results in the FD-OCC4 values encompassed by bordering box 404 (i.e., the kronecker product of the two matrices). These FD-OCC4 values correspond to the second set of 8 DMRS ports (i.e., ports 8-15).

In some implementations, the UE 202 is configured to use a second enhanced DMRS configuration for Type-2 DMRS. The enhanced configuration uses FD-OCC4 and three CDM groups to map DMRS to the resource elements of one or more symbols allocated for DMRS. The enhanced configuration supports up to twelve DMRS ports in one symbol, and up to twenty-four DMRS ports in two symbols. TD-OCC2 can be used to extend the enhanced configuration from one symbol to two symbols.

In some implementations, the UE 202 may be configured with one or more options for the second enhanced DMRS configuration. In a first option, the resource elements allocated to each CDM group are arranged in a repeating pattern in frequency. In each symbol, a first pair of resource elements are allocated to CDM group 0, a second pair of elements is allocated to CDM group 1, and third pair of resource elements is allocated to CDM group 2. This pattern is repeated in frequency. In a second option, in each symbol, each CDM group is allocated a set of resource elements that are consecutive in frequency.

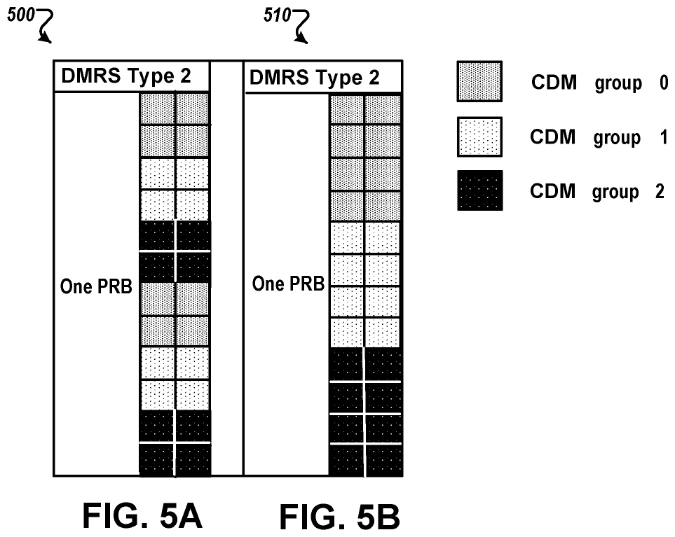

FIGS. 5A, 5B illustrate the second enhanced DMRS configuration for Type-2 DMRS, according to some implementations. In these figures, the second enhanced DMRS configuration uses FD-OCC4, two CDM groups, and is mapped to two symbols using TD-OCC2. Accordingly, the enhanced DMRS configuration supports up to twenty-four DMRS ports. As shown in the figures, however, there are different options for the mapping pattern. Each figure illustrates a different option.

FIG. 5A illustrates a first option 500 of the second enhanced DMRS configuration. As shown in FIG. 5A, the resource elements allocated to each CDM group are arranged in a repeating pattern in frequency. In each symbol, a first pair of resource elements are allocated to CDM group 0, a second pair of elements is allocated to CDM group 1, and third pair of resource elements is allocated to CDM group 2. This pattern is repeated in frequency. Thus, after the third pair of resource elements allocated to CDM group 2, a fourth pair of resource elements is allocated to CDM group 0, and so on. One of the advantages of this option is that it improves back-forward compatibility with legacy configurations (e.g., shown in FIG. 1A). This enables co-scheduling of a UE using the legacy configuration and another UE using the enhanced configuration on the same radio frequency resources.

FIG. 5B illustrates a second option 510 of the second enhanced DMRS configuration. In this option, the resource elements belonging to each CDM group are arranged consecutively in frequency. As shown in FIG. 5B, in each symbol, the resource elements for CDM group 0 are allocated to a first set of consecutive resource elements, the resource elements for CDM group 1 are allocated to a second set of consecutive resource elements arranged in frequency after the first set, and the resource elements for CDM group 2 are allocated to a third set of consecutive resource elements arranged in frequency after the second set. Note that option two is more robust to a frequency selective fading channel, e.g., a channel with large delay spread.

In some implementations, the UE 202 is configured to use an equation to map a DMRS sequence to resource elements of one or more OFDM symbols. In some implementations, the UE 202 is configured to apply the second enhanced DMRS configuration for Type-2 DMRS by selecting certain values for variables in the equations described in TS 38.211, e.g., Equations [1], [2], [3].

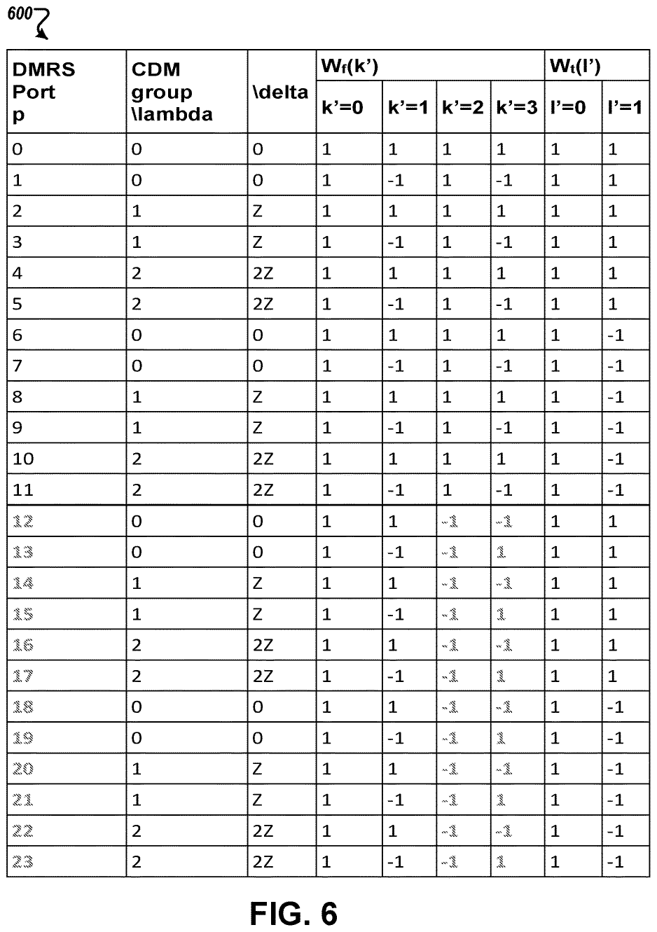

FIG. 6 illustrates a table 600 for DMRS port to DMRS pattern mapping for Type-2 DMRS, according to some implementations. The table 600 specifies the values of the variables \lambda, \delta, W_{f}(k′), Wₜ(l′) to use for mapping up to twenty-four DMRS ports to two symbols. The values of the variables can be used in the equations specified in TS 38.211, e.g., Equations [1], [2], [3]. The different options for the first enhanced DMRS configuration can be achieved by selecting different values of \delta. In particular, in table 600, Z=2 for option 1 and Z=4 for option 2.

In some implementations, the FD-OCC4 in table 600 can be generated based on an FD-OCC2 used in existing DMRS configurations. The existing FD-OCC2 for Type-2 DMRS is shown in Table 2:

TABLE 2

W_{f}(k′)

| DMRS Port | k′ = 0 | k′ = 1 |
|---|---|---|
| 0 | 1 | 1 |
| 1 | 1 | −1 |
| 2 | 1 | 1 |
| 3 | 1 | −1 |
| 4 | 1 | 1 |
| 5 | 1 | −1 |
| 6 | 1 | 1 |
| 7 | 1 | −1 |
| 8 | 1 | 1 |
| 9 | 1 | −1 |
| 10 | 1 | 1 |
| 11 | 1 | −1 |

In an example, to generate the FD-OCC4 in table 600, the values in Table 2 are first multiplied by the matrix {1,1}. This multiplication results in FD-OCC4 values that correspond to the first set of twelve DMRS ports in table 600 (i.e., ports 0-11). Then, the values in Table 2 are multiplied by the matrix {1,−1}. This multiplication results in the FD-OCC4 values that correspond to the second set of twelve DMRS ports (i.e., ports 12-23).

In some implementations, the UE 202 is configured to use a third enhanced DMRS configuration for Type-1 DMRS. The enhanced configuration uses a length-6 FD-OCC (FD-OCC6), two CDM groups, and TD-OCC2 to map DMRS (and the associated DMRS ports) to the resource elements to two symbols allocated for DMRS. The enhanced configuration supports up to twenty-four DMRS ports in two symbols. For this enhanced DMRS configuration, the FD-OCC6 is based on a cyclic shift code, such as a Discrete Fourier Transform (DFT) code. The FD-OCC6 based on DFT includes the following six codes: {1, 1, 1, 1, 1, 1}; {1, −1, 1, −1, 1, −1}; {1, a¹, a², a³, a⁴, a⁵}; {1, a², a⁴, a⁶, a⁸, a¹⁰}; {1, a⁴, a⁸, a¹², a¹⁶, a²⁰}; {1, a⁵, a¹⁰, a¹⁵, a²⁰, a²⁵}, where a=exp{2πj/6}=1/2+j\sqrt{3}/2. The six codes are generated based on the Discrete Fourier Transform (DFT) of size 6.

In some implementations, the UE 202 may be configured with one or more options for the third enhanced DMRS configuration. In a first option, each CDM group is allocated every second resource element in a symbol. This allocation creates a “comb” where resource elements belonging to the same CDM group are not adjacent in frequency. In a second option, each CDM group is allocated two sets of three resource elements that are adjacent in frequency. In this option, each set of three resource elements belonging to the same CDM group are separated by a set of three of resource elements belonging to the other CDM group. In a third option, each CDM group is allocated a set of resource elements that are consecutive in frequency.

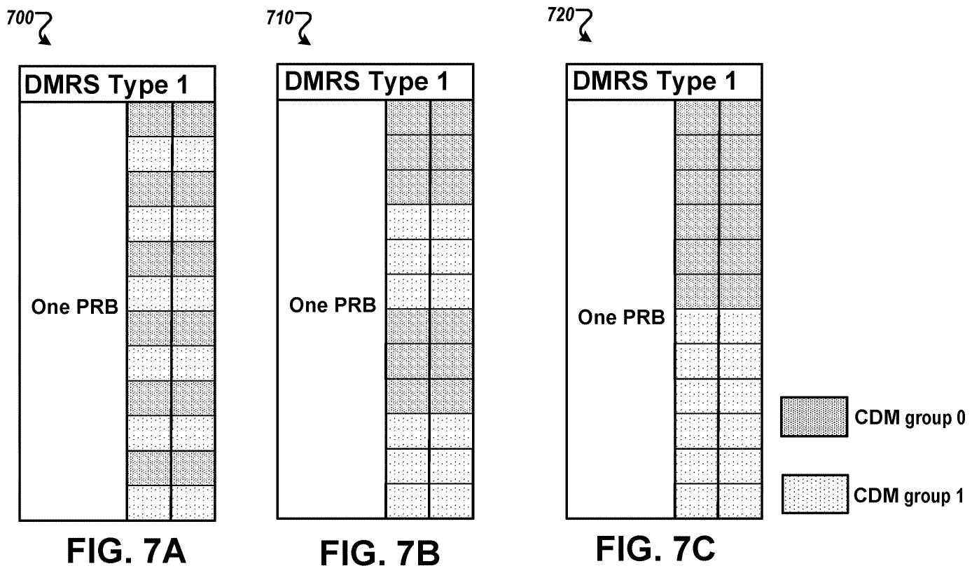

FIGS. 7A, 7B illustrate a third enhanced DMRS configuration for Type-1 DMRS, according to some implementations. FIG. 7A illustrates a first option 700 of the third enhanced DMRS configuration. As shown in FIG. 7A, each CDM group is allocated every second resource element in a symbol. This creates a “comb” where resource elements belonging to the same CDM group are not adjacent in frequency. Thus, as shown in FIG. 7A, in each symbol, a first resource element is allocated to CDM group 0, a second resource element is allocated to CDM group 1, a third resource element is allocated to CDM group 0, and so on. One of the advantages of this option is that it improves back-forward compatibility with legacy configurations (e.g., shown in FIG. 1A). This enables co-scheduling of a UE using the legacy configuration and another UE using the enhanced configuration on the same radio frequency resources.

FIG. 7B illustrates a second option 710 of the third enhanced DMRS configuration. As shown in FIG. 7B, in each symbol, each CDM group is allocated two sets of three resource elements that are adjacent in frequency. In this option, each set of resource elements belonging to the same CDM group are separated by another set of resource elements belonging to the other CDM group. As shown in FIG. 7B, in each symbol, a first set of three resource elements is allocated to CDM group 0, and a second set of three resource elements, adjacent in frequency to the first set, are allocated to CDM group 1. Further, a third set of resource elements, adjacent in frequency to the second set, is allocated to CDM group 0, and a fourth set of resource elements, adjacent in frequency to the third set, is allocated to CDM group 1.

FIG. 7C illustrates a third option 720 of the third enhanced DMRS configuration. In this option, the resource elements belonging to each CDM group are arranged consecutively in frequency. As shown in FIG. 7C, in each symbol, the resource elements for CDM group 0 are allocated to a first set of consecutive resource elements, and the resource elements for CDM group 1 are allocated to a second set of consecutive resource elements arranged in frequency after the first set. Note that options two and three are more robust to a frequency selective fading channel, with the third option being the most robust to a frequency selective fading channel, e.g., a channel with large delay spread.

In some implementations, the UE 202 is configured to use an equation to map a DMRS sequence to resource elements of one or more symbols to achieve the third DMRS configuration shown in FIG. 7A-7C. In some implementations, the UE 202 is configured to apply the third enhanced DMRS configuration for Type-1 DMRS by selecting certain values for variables in the equations described in TS 38.211, e.g., Equations [1], [2], [3].

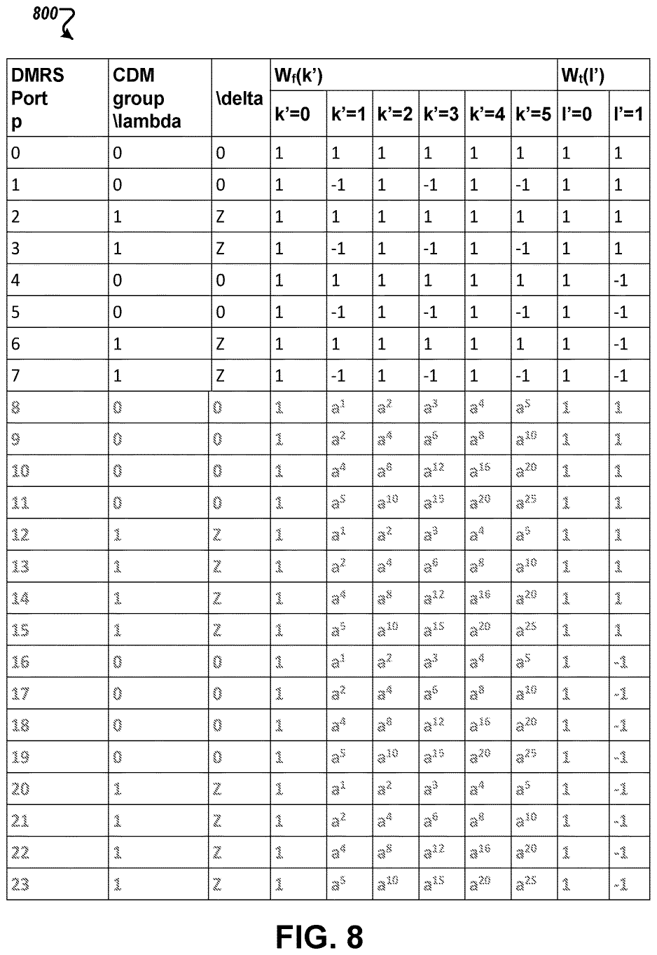

FIG. 8 illustrates a table 800 for DMRS port to DMRS pattern mapping for Type-1 DMRS, according to some implementations. The table 800 specifies the values of the variables \lambda, \delta, W_{f}(k′), Wₜ(l′) to use for mapping up to twenty-four DMRS ports to two symbols. The values of the variables can be used in the equations specified in TS 38.211. The different options for the first enhanced DMRS configuration can be achieved by selecting different values of \delta. In particular, in table 800, Z=1, for option 1, Z=3 for option 1, and Z=6 for option 3.

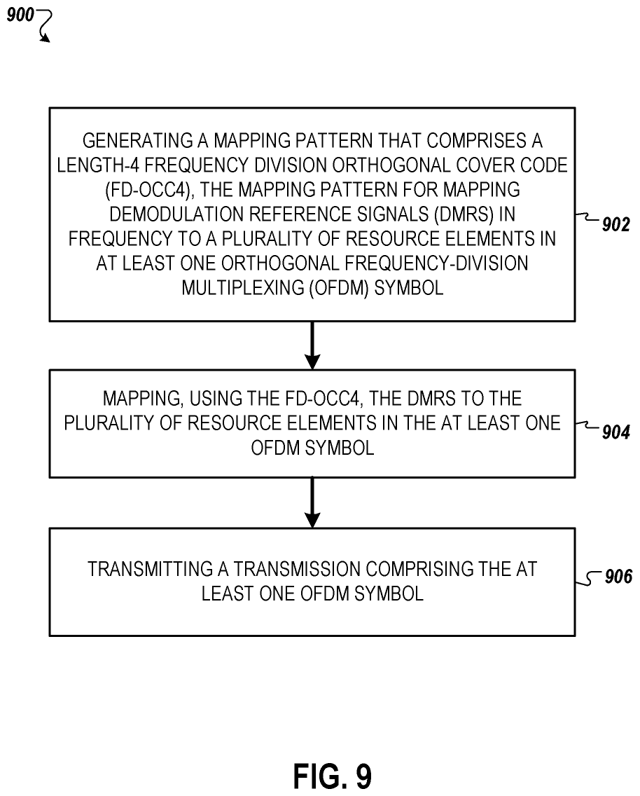

FIG. 9 illustrates a flowchart of an example method 900, in accordance with some embodiments. For clarity of presentation, the description that follows generally describes method 900 in the context of the other figures in this description. For example, method 900 can be performed by UE 202 or base station 204 of FIG. 2. It will be understood that method 900 can be performed, for example, by any suitable system, environment, software, hardware, or a combination of systems, environments, software, and hardware, as appropriate. In some implementations, various steps of method 900 can be run in parallel, in combination, in loops, or in any order.

At step 902, method 900 involves generating a mapping pattern that comprises a length-4 frequency division orthogonal cover code (FD-OCC 4), the mapping pattern for mapping demodulation reference signals (DMRS) in frequency to a plurality of resource elements in at least one orthogonal frequency-division multiplexing (OFDM) symbol, where the DMRS are associated with a plurality of DMRS ports.

At step 904, method 900 involves mapping, using the FD-OCC 4, the DMRS to the plurality of resource elements in the at least one OFDM symbol.

At step 906, method 900 involves transmitting a transmission comprising the at least one OFDM symbol.

In some implementations, the at least one OFDM symbol is two OFDM symbols.

In some implementations, the mapping pattern further includes a length-2 time division OCC (TD-OCC 2) that maps the DMRS in time to the two OFDM symbols.

In some implementations, the mapping pattern further includes a plurality of code division multiplexing (CDM) groups, each of the plurality of CDM groups associated with a respective subset of the plurality of DMRS ports.

In some implementations, mapping, using the FD-OCC 4, the DMRS to the plurality of resource elements involves mapping the DMRS such that DMRS associated with the same CDM group are not mapped to resource elements adjacent in frequency.

In some implementations, mapping, using the FD-OCC 4, the DMRS to the plurality of resource elements involves mapping the DMRS such that DMRS associated with the same CDM group are mapped to resource elements adjacent in frequency.

In some implementations, the DMRS associated with the same CDM group are mapped to consecutive resource elements in frequency.

In some implementations, the number of the plurality of CDM groups is 2 or 3. In some implementations, a different number of CDM groups is be used.

In some implementations, the at least one OFDM symbol is two OFDM symbols, and wherein number of the plurality of DMRS ports is 16 or 24. In some implementations, a different number of DMRS ports is be used.

In some implementations, the at least one OFDM symbol is one OFDM symbol, and wherein number of the plurality of DMRS ports is 8 or 12. In some implementations, a different number of DMRS ports is be used.

In some implementations, the mapping pattern repeats in frequency.

In some implementations, the DMRS is one of Type 1 DMRS or Type 2 DMRS.

In some implementations, generating the mapping pattern involves determining a first table representing a length-2 FD-OCC (FD-OCC2) DMRS configuration, where the first table includes X rows, and each row includes a respective FD-OCC2 for a corresponding DMRS port; and generating, using the first table, a second table that represents the FD-OCC4. The second table is generated by generating a first set of X rows of the second table by multiplying the respective FD-OCC2 from each corresponding row in the first table by a {1,1} matrix; and generating a second set of X rows of the second table by multiplying the respective FD-OCC2 from each corresponding row in the first table by a {1,−1} matrix.

In some implementations, the first table is:

W_{f}(k′)

| DMRS Port | k′ = 0 | k′ = 1 |
|---|---|---|
| 0 | 1 | 1 |
| 1 | 1 | −1 |
| 2 | 1 | 1 |
| 3 | 1 | −1 |
| 4 | 1 | 1 |
| 5 | 1 | −1 |
| 6 | 1 | 1 |
| 7 | 1 | −1 |

In some implementations, the first table is.

W_{f}(k′)

| DMRS Port | k′ = 0 | k′ = 1 |
|---|---|---|
| 0 | 1 | 1 |
| 1 | 1 | −1 |
| 2 | 1 | 1 |
| 3 | 1 | −1 |
| 4 | 1 | 1 |
| 5 | 1 | −1 |
| 6 | 1 | 1 |
| 7 | 1 | −1 |
| 8 | 1 | 1 |
| 9 | 1 | −1 |
| 10 | 1 | 1 |
| 11 | 1 | −1 |

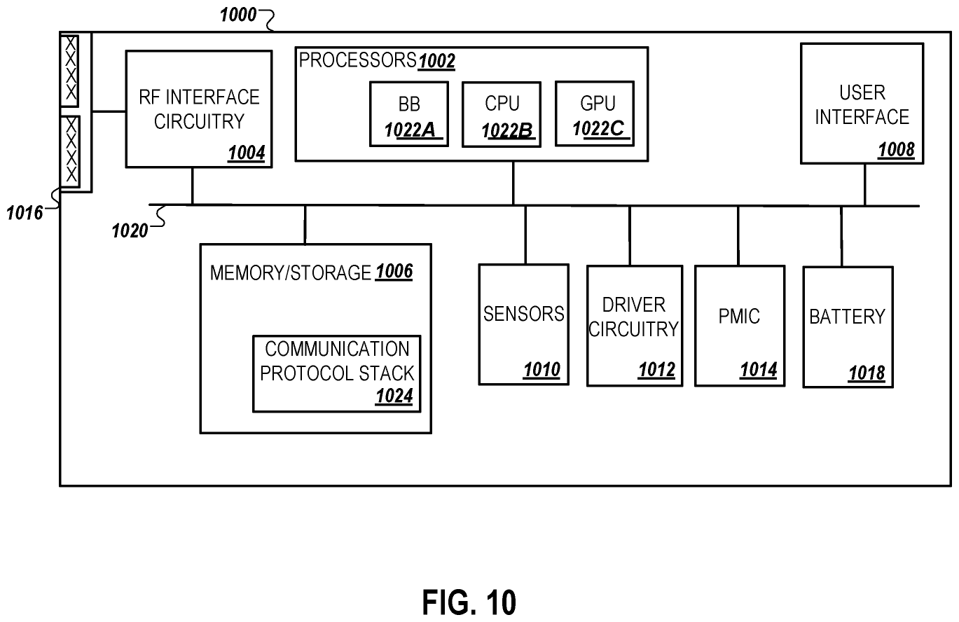

FIG. 10 illustrates a UE 1000, in accordance with some embodiments. The UE 1000 may be similar to and substantially interchangeable with UE 202 of FIG. 2.

The UE 1000 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 1000 may include processors 1002, RF interface circuitry 1004, memory/storage 1006, user interface 1008, sensors 1010, driver circuitry 1012, power management integrated circuit (PMIC) 1014, one or more antennas 1016, and battery 1018. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1020, which may represent any type of interface, input/output, bus (local, system, or expansion), transmission line, trace, optical connection, etc. that allows various circuit components (on common or different chips or chipsets) to interact with one another.

The processors 1002 may include processor circuitry such as, for example, baseband processor circuitry (BB) 1022A, central processor unit circuitry (CPU) 1022B, and graphics processor unit circuitry (GPU) 1022C. The processors 1002 may include any type of circuitry or processor circuitry that executes or otherwise operates computer-executable instructions, such as program code, software modules, or functional processes from memory/storage 1006 to cause the UE 1000 to perform operations as described herein.

In some implementations, the processors 1002 are configured to generate a mapping pattern that comprises a length-4 frequency division orthogonal cover code (FD-OCC 4), the mapping pattern for mapping demodulation reference signals (DMRS) in frequency to a plurality of resource elements in at least one orthogonal frequency-division multiplexing (OFDM) symbol, where the DMRS are associated with a plurality of DMRS ports. The processors 1002 are configured to map, using the FD-OCC 4, the DMRS to the plurality of resource elements in the at least one OFDM symbol. Further, the processors 1002 are configured to transmit a transmission comprising the at least one OFDM symbol.

In some implementations, the baseband processor circuitry 1022A may access a communication protocol stack 1024 in the memory/storage 1006 to communicate over a 3GPP compatible network. In general, the baseband processor circuitry 1022A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1004. The baseband processor circuitry 1022A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 1006 may include one or more non-transitory, computer-readable media that includes instructions (for example, communication protocol stack 1024) that may be executed by one or more of the processors 1002 to cause the UE 1000 to perform various operations described herein. The memory/storage 1006 include any type of volatile or non-volatile memory that may be distributed throughout the UE 1000. In some implementations, some of the memory/storage 1006 may be located on the processors 1002 themselves (for example, L1 and L2 cache), while other memory/storage 1006 is external to the processors 1002 but accessible thereto via a memory interface. The memory/storage 1006 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1004 may include transceiver circuitry and radio frequency front module (RFEM) that allows the UE 1000 to communicate with other devices over a radio access network. The RF interface circuitry 1004 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via one or more antennas 1016 and proceed to filter and amplify (with a low-noise amplifier) the signal. The signal may be provided to a receiver of the transceiver that down-converts the RF signal into a baseband signal that is provided to the baseband processor of the processors 1002.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1016. In various implementations, the RF interface circuitry 1004 may be configured to transmit/receive signals in a manner compatible with NR access technologies.

The antenna 1016 may include antenna elements to convert electrical signals into radio waves to travel through the air and to convert received radio waves into electrical signals. The antenna elements may be arranged into one or more antenna panels. The antenna 1016 may have antenna panels that are omnidirectional, directional, or a combination thereof to enable beamforming and multiple input, multiple output communications. The antenna 1016 may include microstrip antennas, printed antennas fabricated on the surface of one or more printed circuit boards, patch antennas, phased array antennas, etc. The antenna 1016 may have one or more panels designed for specific frequency bands including bands in FR1 or FR2.

The user interface 1008 includes various input/output (I/O) devices designed to enable user interaction with the UE 1000. The user interface 1008 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1000.

The sensors 1010 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1012 may include software and hardware elements that operate to control particular devices that are embedded in the UE 1000, attached to the UE 1000, or otherwise communicatively coupled with the UE 1000. The driver circuitry 1012 may include individual drivers allowing other components to interact with or control various input/output (I/O) devices that may be present within, or connected to, the UE 1000. For example, driver circuitry 1012 may include a display driver to control and allow access to a display device, a touchscreen driver to control and allow access to a touchscreen interface, sensor drivers to obtain sensor readings of sensors 1010 and control and allow access to sensors 1010, drivers to obtain actuator positions of electro-mechanic components or control and allow access to the electro-mechanic components, a camera driver to control and allow access to an embedded image capture device, audio drivers to control and allow access to one or more audio devices.

The PMIC 1014 may manage power provided to various components of the UE 1000. In particular, with respect to the processors 1002, the PMIC 1014 may control power-source selection, voltage scaling, battery charging, or DC-to-DC conversion.

In some implementations, the PMIC 1014 may control, or otherwise be part of, various power saving mechanisms of the UE 1000. A battery 1018 may power the UE 1000, although in some examples the UE 1000 may be mounted deployed in a fixed location and may have a power supply coupled to an electrical grid. The battery 1018 may be a lithium-ion battery, a metal-air battery, such as a zinc-air battery, an aluminum-air battery, a lithium-air battery, and the like. In some implementations, such as in vehicle-based applications, the battery 1018 may be a typical lead-acid automotive battery.

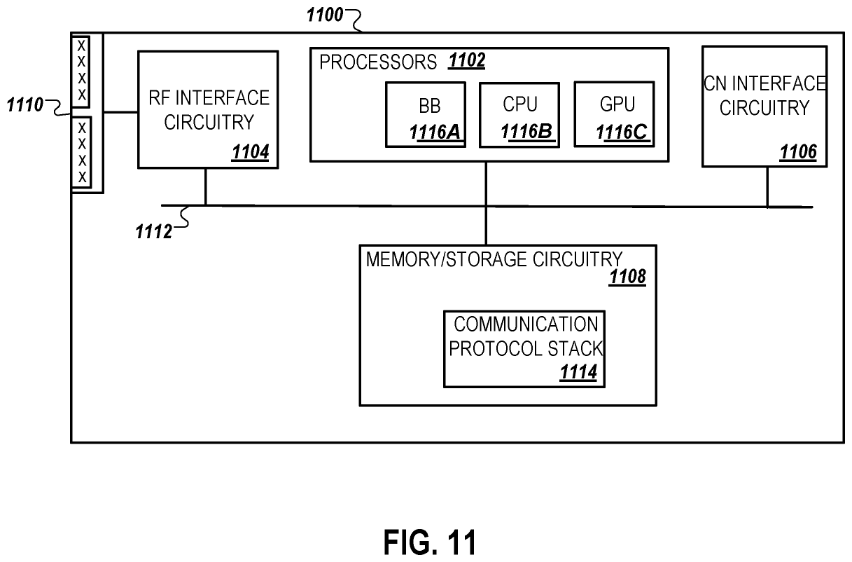

FIG. 11 illustrates an access node 1100 (e.g., a base station or gNB), according to some implementations. The access node 1100 may be similar to and substantially interchangeable with base station X104. The access node 1100 may include processors 1102, RF interface circuitry 1104, core network (CN) interface circuitry 1106, memory/storage circuitry 1108, and one or more antennas 1110.

The components of the access node 1100 may be coupled with various other components over one or more interconnects 1112. The processors 1102, RF interface circuitry 1104, memory/storage circuitry 1108 (including communication protocol stack 1114), one or more antennas 1110, and interconnects 1112 may be similar to like-named elements shown and described with respect to FIG. 10. For example, the processors 1102 may include processor circuitry such as, for example, baseband processor circuitry (BB) 1116A, central processor unit circuitry (CPU) 1116B, and graphics processor unit circuitry (GPU) 1116C.

In some implementations, the processors 1102 are configured to generate a mapping pattern that comprises a length-4 frequency division orthogonal cover code (FD-OCC 4), the mapping pattern for mapping demodulation reference signals (DMRS) in frequency to a plurality of resource elements in at least one orthogonal frequency-division multiplexing (OFDM) symbol, where the DMRS are associated with a plurality of DMRS ports. The processors 1102 are configured to map, using the FD-OCC 4, the DMRS to the plurality of resource elements in the at least one OFDM symbol. Further, the processors 1102 are configured to transmit a transmission comprising the at least one OFDM symbol.

The CN interface circuitry 1106 may provide connectivity to a core network, for example, a 5th Generation Core network (5GC) using a 5GC-compatible network interface protocol such as carrier Ethernet protocols, or some other suitable protocol. Network connectivity may be provided to/from the access node 1100 via a fiber optic or wireless backhaul. The CN interface circuitry 1106 may include one or more dedicated processors or FPGAs to communicate using one or more of the aforementioned protocols. In some implementations, the CN interface circuitry 1106 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1100 that operates in an NR or 5G system (for example, a gNB), and the term “E-UTRAN node” or the like may refer to an access node 1100 that operates in an LTE or 4G system (e.g., an eNB). According to various implementations, the access node 1100 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1100 may be implemented as one or more software entities running on server computers as part of a virtual network, which may be referred to as a CRAN and/or a virtual baseband unit pool (vBBUP). In V2X scenarios, the access node 1100 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example 1 includes one or more processors of a transmitting device, the one or more processors configured to cause the transmitting device to perform operations including generating a mapping pattern that includes a length-4 frequency division orthogonal cover code (FD-OCC4), the mapping pattern for mapping demodulation reference signals (DMRS) in frequency to a plurality of resource elements in at least one orthogonal frequency-division multiplexing (OFDM) symbol, where the DMRS are associated with a plurality of DMRS ports; mapping, using the FD-OCC4, the DMRS to the plurality of resource elements in the at least one OFDM symbol; and transmitting a transmission comprising the at least one OFDM symbol.

Example 2 is the one more processors of Example 1, where the at least one OFDM symbol is two OFDM symbols.

Example 3 is the one more processors of any of Examples 1 or 2, where the mapping pattern further comprises a length-2 time division OCC (TD-OCC2) that maps the DMRS in time to the two OFDM symbols.

Example 4 is the one more processors of any of Examples 1-3, where the mapping pattern further comprises a plurality of code division multiplexing (CDM) groups, each of the plurality of CDM groups associated with a respective subset of the plurality of DMRS ports.

Example 5 is the one more processors of any of Examples 1-3, where the mapping pattern further comprises a plurality of code division multiplexing (CDM) groups, each of the plurality of CDM groups associated with a respective subset of the plurality of DMRS ports.

Example 6 is the one more processors of claim 4, where mapping, using the FD-OCC4, the DMRS to the plurality of resource elements includes: mapping the DMRS such that DMRS associated with the same CDM group are mapped to resource elements adjacent in frequency.

Example 7 is the one more processors of Example 6, where the DMRS associated with the same CDM group are mapped to consecutive resource elements in frequency.

Example 8 is the one more processors of Example 4, where the number of the plurality of CDM groups is 2 or 3.

Example 9 is the one more processors of any of Example 1-8, where the at least one OFDM symbol is two OFDM symbols, and where number of the plurality of DMRS ports is 16 or 24.

Example 10 is the one more processors of Example 1, where the at least one OFDM symbol is one OFDM symbol, and where number of the plurality of DMRS ports is 8 or 12.

Example 11 is the one more processors of any of Examples 1-10, where the mapping pattern repeats in frequency.

Example 12 is the one more processors of any of Examples 1-10, where the DMRS is one of Type 1 DMRS or Type 2 DMRS.

Example 13 is the one more processors of Example 1, where generating the mapping pattern includes: determining a first table representing a length-2 FD-OCC (FD-OCC2) DMRS configuration, where the first table comprises X rows, and each row includes a respective FD-OCC2 for a corresponding DMRS port; and generating, using the first table, a second table that represents the FD-OCC4, where the second table is generated by: generating a first set of X rows of the second table by multiplying the respective FD-OCC2 from each corresponding row in the first table by a {1,1} matrix; and generating a second set of X rows of the second table by multiplying the respective FD-OCC2 from each corresponding row in the first table by a {1,−1} matrix.

Example 14 is the one more processors of Example 13, where the first table is:

W_{f}(k′)

| DMRS Port | k′ = 0 | k′ = 1 |
|---|---|---|
| 0 | 1 | 1 |
| 1 | 1 | −1 |
| 2 | 1 | 1 |
| 3 | 1 | −1 |
| 4 | 1 | 1 |
| 5 | 1 | −1 |
| 6 | 1 | 1 |
| 7 | 1 | −1 |

Example 15 is the one more processors of Example 13, where the first table is:

W_{f}(k′)

| DMRS Port | k′ = 0 | k′ = 1 |
|---|---|---|
| 0 | 1 | 1 |
| 1 | 1 | −1 |
| 2 | 1 | 1 |
| 3 | 1 | −1 |
| 4 | 1 | 1 |
| 5 | 1 | −1 |
| 6 | 1 | 1 |
| 7 | 1 | −1 |
| 8 | 1 | 1 |
| 9 | 1 | −1 |
| 10 | 1 | 1 |
| 11 | 1 | −1 |

Example 16 may include a non-transitory computer storage medium encoded with instructions that, when executed by one or more computers, cause the one or more computers to perform the operations of any of Examples 1 to 15.

Example 17 may include a system including one or more computers and one or more storage devices on which are stored instructions that are operable, when executed by the one or more computers, to cause the one or more computers to perform the operations of any of Examples 1 to 15.

Example 18 may include a method for performing the operations of any of Examples 1 to 15.

Example 19 may include an apparatus including logic, modules, or circuitry to perform one or more elements of the operations described in or related to any of Examples 1-15, or any other operations or process described herein.

Example 20 may include a method, technique, or process as described in or related to the operations of any of Examples 1-15, or portions or parts thereof.

Example 21 may include an apparatus, e.g., a user equipment, including: one or more processors and one or more computer-readable media including instructions that, when executed by the one or more processors, cause the one or more processors to perform the method, techniques, or process as described in or related to the operations of any of Examples 1-15, or portions thereof.

Example 22 may include a computer program including instructions, where execution of the program by a processing element is to cause the processing element to carry out the method, techniques, or process as described in or related to the operations of any of Examples 1-15, or portions thereof. The operations or actions performed by the instructions executed by the processing element can include the operations of any one of Examples 1-15.

Example 23 may include a method of communicating in a wireless network as shown and described herein.

Example 24 may include a system for providing wireless communication as shown and described herein. The operations or actions performed by the system can include the operations of any one of Examples 1-15.

Example 25 may include a device for providing wireless communication as shown and described herein. The operations or actions performed by the device can include the operations of any one of Examples 1-15.

The previously-described operations of Examples 1-15 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. One or more processors of a transmitting device, the one or more processors configured to cause the transmitting device to perform operations comprising:
generating a mapping pattern that maps demodulation reference signals (DMRS) in a frequency domain to a plurality of resource elements in at least one orthogonal frequency-division multiplexing (OFDM) symbol;
mapping, using a length-4 frequency division orthogonal cover code (FD-OCC4), the DMRS to the plurality of resource elements in the at least one OFDM symbol based on the mapping pattern; and
transmitting the DMRS on the at least one OFDM symbol.

2. The one or more processors of claim 1, wherein the at least one OFDM symbol is two OFDM symbols.

3. The one or more processors of claim 2, wherein the mapping pattern maps, using a length-2 time division OCC (TD-OCC2), the DMRS in time to the two OFDM symbols.

4. The one or more processors of claim 1, wherein the DMRS are associated with a plurality of DMRS ports and wherein the mapping pattern further comprises a plurality of code division multiplexing (CDM) groups, each of the plurality of CDM groups associated with a respective subset of the plurality of DMRS ports.

5. The one or more processors of claim 4, wherein mapping, using the FD-OCC4, the DMRS to the plurality of resource elements comprises:
mapping the DMRS such that DMRS associated with the same CDM group are not mapped to resource elements adjacent in frequency.

6. The one or more processors of claim 4, wherein mapping, using the FD-OCC4, the DMRS to the plurality of resource elements comprises:
mapping the DMRS such that DMRS associated with the same CDM group are mapped to resource elements adjacent in frequency.

7. The one or more processors of claim 6, wherein the DMRS associated with the same CDM group are mapped to consecutive resource elements in frequency.

8. (canceled)

9. (canceled)

10. (canceled)

11. The one or more processors of claim 1, wherein the mapping pattern repeats in frequency.

12. The one or more processors of claim 1, wherein the DMRS is one of Type 1 DMRS or Type 2 DMRS.

13. The one or more processors of claim 1, wherein the FD-OCC4 is based on a first table, and wherein generating the mapping pattern comprises:
determining a second table representing a length-2 FD-OCC (FD-OCC2) DMRS configuration, wherein the second table comprises X rows, and each row includes a respective FD-OCC2 for a corresponding DMRS port; and
generating, using the second table, the first table that represents the FD-OCC4, wherein the first table is generated by:
generating a first set of X rows of the first table by multiplying the respective FD-OCC2 from each corresponding row in the second table by a {1,1} matrix; and
generating a second set of X rows of the first table by multiplying the respective FD-OCC2 from each corresponding row in the second table by a {1,−1} matrix.

14. The one or more processors of claim 10, wherein the second table is:
W_{f}(k′)

| DMRS Port | k′ = 0 | k′ = 1 |
|---|---|---|
| P0 | 1 | 1 |
| P0 + 1 | 1 | −1 |
| P0 + 2 | 1 | 1 |
| P0 + 3 | 1 | −1 |
| P0 + 4 | 1 | 1 |
| P0 + 5 | 1 | −1 |
| P0 + 6 | 1 | 1 |
| P0 + 7 | 1 | −1 |

15. The one or more processors of claim 10, wherein the second table is:
W_{f}(k′)

| DMRS Port | k′ = 0 | k′ = 1 |
|---|---|---|
| P0 | 1 | 1 |
| P0 + 1 | 1 | −1 |
| P0 + 2 | 1 | 1 |
| P0 + 3 | 1 | −1 |
| P0 + 4 | 1 | 1 |
| P0 + 5 | 1 | −1 |
| P0 + 6 | 1 | 1 |
| P0 + 7 | 1 | −1 |
| P0 + 8 | 1 | 1 |
| P0 + 9 | 1 | −1 |
| P0 + 10 | 1 | 1 |
| P0 + 11 | 1 | −1 |

16. A user equipment (UE) comprising:
memory;
a transceiver; and
a processor coupled to the memory and configured to, when executing instructions stored in the memory, cause the UE to perform operations comprising:
generating a mapping pattern that maps demodulation reference signals (DMRS) in a frequency domain to a plurality of resource elements in at least one orthogonal frequency-division multiplexing (OFDM) symbol;
mapping, using a length-4 frequency division orthogonal cover code (FD-OCC4), the DMRS to the plurality of resource elements in the at least one OFDM symbol based on the mapping pattern; and
transmitting the DMRS on the at least one OFDM symbol.

17. (canceled)

18. A method comprising:
generating a mapping pattern that maps demodulation reference signals (DMRS) in a frequency domain to a plurality of resource elements in at least one orthogonal frequency-division multiplexing (OFDM) symbol;
mapping, using a length-4 frequency division orthogonal cover code (FD-OCC4), the DMRS to the plurality of resource elements in the at least one OFDM symbol based on the mapping pattern; and
transmitting the DMRS on the at least one OFDM symbol.

19. The one or more processors of claim 1, wherein the mapping pattern is based on a first table, the first table being:

| | CDM | | W_{f}(k′) | | | | Wₜ(l′) | |
|---|---|---|---|---|---|---|---|---|
| DMRS Port | Group λ | Δ | k′ = 0 | k′ = 1 | k′ = 2 | k′ = 3 | l′ = 0 | l′ = 1 |
| P0 | 0 | 0 | 1 | 1 | 1 | 1 | 1 | 1 |
| P0 + 1 | 0 | 0 | 1 | −1 | 1 | −1 | 1 | 1 |
| P0 + 2 | 1 | Z | 1 | 1 | 1 | 1 | 1 | 1 |
| P0 + 3 | 1 | Z | 1 | −1 | 1 | −1 | 1 | 1 |
| P0 + 4 | 0 | 0 | 1 | 1 | 1 | 1 | 1 | −1 |
| P0 + 5 | 0 | 0 | 1 | −1 | 1 | −1 | 1 | −1 |
| P0 + 6 | 1 | Z | 1 | 1 | 1 | 1 | 1 | −1 |
| P0 + 7 | 1 | Z | 1 | −1 | 1 | −1 | 1 | −1 |
| P0 + 8 | 0 | 0 | 1 | 1 | −1 | −1 | 1 | 1 |
| P0 + 9 | 0 | 0 | 1 | −1 | −1 | 1 | 1 | 1 |
| P0 + 10 | 1 | Z | 1 | 1 | −1 | −1 | 1 | 1 |
| P0 + 11 | 1 | Z | 1 | −1 | −1 | 1 | 1 | 1 |
| P0 + 12 | 0 | 0 | 1 | 1 | −1 | −1 | 1 | −1 |
| P0 + 13 | 0 | 0 | 1 | −1 | −1 | 1 | 1 | −1 |
| P0 + 14 | 1 | Z | 1 | 1 | −1 | −1 | 1 | −1 |
| P0 + 15 | 1 | Z | 1 | −1 | −1 | 1 | 1 | −1 |

and wherein Z is 1 and wherein:
Δ represents a distance in a unit of number of REs for a code division multiplexing (CDM) group λ,
W_{f}(k′) represents the FD-0004 applied on a resource element (k′, l′) in the frequency domain in the CDM group λ, and
Wₜ(l′) represents a length-2 time division OCC (TD-0002) applied on the resource element (k′, l′) in a time domain in the CDM group λ.

20. The one or more processors of claim 1, wherein the mapping pattern is based on a first table, the first table being:

| | CDM | | W_{f}(k′) | | | | Wₜ(l′) | |
|---|---|---|---|---|---|---|---|---|
| DMRS Port | Group λ | Δ | k′ = 0 | k′ = 1 | k′ = 2 | k′ = 3 | l′ = 0 | l′ = 1 |
| P0 | 0 | 0 | 1 | 1 | 1 | 1 | 1 | 1 |
| P0 + 1 | 0 | 0 | 1 | −1 | 1 | −1 | 1 | 1 |
| P0 + 2 | 1 | Z | 1 | 1 | 1 | 1 | 1 | 1 |
| P0 + 3 | 1 | Z | 1 | −1 | 1 | −1 | 1 | 1 |
| P0 + 4 | 2 | 2*Z | 1 | 1 | 1 | 1 | 1 | 1 |
| P0 + 5 | 2 | 2*Z | 1 | −1 | 1 | −1 | 1 | 1 |
| P0 + 6 | 0 | 0 | 1 | 1 | 1 | 1 | 1 | −1 |
| P0 + 7 | 0 | 0 | 1 | −1 | 1 | −1 | 1 | −1 |
| P0 + 8 | 1 | Z | 1 | 1 | 1 | 1 | 1 | −1 |
| P0 + 9 | 1 | Z | 1 | −1 | 1 | −1 | 1 | −1 |
| P0 + 10 | 2 | 2*Z | 1 | 1 | 1 | 1 | 1 | −1 |
| P0 + 11 | 2 | 2*Z | 1 | −1 | 1 | −1 | 1 | −1 |
| P0 + 12 | 0 | 0 | 1 | 1 | −1 | −1 | 1 | 1 |
| P0 + 13 | 0 | 0 | 1 | −1 | −1 | 1 | 1 | 1 |
| P0 + 14 | 1 | Z | 1 | 1 | −1 | −1 | 1 | 1 |
| P0 + 15 | 1 | Z | 1 | −1 | −1 | 1 | 1 | 1 |
| P0 + 16 | 2 | 2*Z | 1 | 1 | −1 | −1 | 1 | 1 |
| P0 + 17 | 2 | 2*Z | 1 | −1 | −1 | 1 | 1 | 1 |
| P0 + 18 | 0 | 0 | 1 | 1 | −1 | −1 | 1 | −1 |
| P0 + 19 | 0 | 0 | 1 | −1 | −1 | 1 | 1 | −1 |
| P0 + 20 | 1 | Z | 1 | 1 | −1 | −1 | 1 | −1 |
| P0 + 21 | 1 | Z | 1 | −1 | −1 | 1 | 1 | −1 |
| P0 + 22 | 2 | 2*Z | 1 | 1 | −1 | −1 | 1 | −1 |
| P0 + 23 | 2 | 2*Z | 1 | −1 | −1 | 1 | 1 | −1 |

and wherein Z is 2 and wherein:
Δ represents a distance in a unit of number of REs for a code division multiplexing (CDM) group λ,
W_{f}(k′) represents the FD-0004 applied on a resource element (k′, l′) in the frequency domain in the CDM group λ, and
Wₜ(l′) represents a length-2 time division OCC (TD-0002) applied on the resource element (k′, l′) in a time domain in the CDM group λ.

21. The UE of claim 16, wherein the mapping pattern is based on a first table, the first table being:

| | CDM | | W_{f}(k′) | | | | Wₜ(l′) | |
|---|---|---|---|---|---|---|---|---|
| DMRS Port | Group λ | Δ | k′ = 0 | k′ = 1 | k′ = 2 | k′ = 3 | l′ = 0 | l′ = 1 |
| P0 | 0 | 0 | 1 | 1 | 1 | 1 | 1 | 1 |
| P0 + 1 | 0 | 0 | 1 | −1 | 1 | −1 | 1 | 1 |
| P0 + 2 | 1 | Z | 1 | 1 | 1 | 1 | 1 | 1 |
| P0 + 3 | 1 | Z | 1 | −1 | 1 | −1 | 1 | 1 |
| P0 + 4 | 0 | 0 | 1 | 1 | 1 | 1 | 1 | −1 |
| P0 + 5 | 0 | 0 | 1 | −1 | 1 | −1 | 1 | −1 |
| P0 + 6 | 1 | Z | 1 | 1 | 1 | 1 | 1 | −1 |
| P0 + 7 | 1 | Z | 1 | −1 | 1 | −1 | 1 | −1 |
| P0 + 8 | 0 | 0 | 1 | 1 | −1 | −1 | 1 | 1 |
| P0 + 9 | 0 | 0 | 1 | −1 | −1 | 1 | 1 | 1 |
| P0 + 10 | 1 | Z | 1 | 1 | −1 | −1 | 1 | 1 |
| P0 + 11 | 1 | Z | 1 | −1 | −1 | 1 | 1 | 1 |
| P0 + 12 | 0 | 0 | 1 | 1 | −1 | −1 | 1 | −1 |
| P0 + 13 | 0 | 0 | 1 | −1 | −1 | 1 | 1 | −1 |
| P0 + 14 | 1 | Z | 1 | 1 | −1 | −1 | 1 | −1 |
| P0 + 15 | 1 | Z | 1 | −1 | −1 | 1 | 1 | −1 |

and wherein Z is 1 and wherein:
Δ represents a distance in a unit of number of REs for a code division multiplexing (CDM) group λ,
W_{f}(k′) represents the FD-0004 applied on a resource element (k′, l′) in the frequency domain in the CDM group λ, and
Wₜ(l′) represents a length-2 time division OCC (TD-0002) applied on the resource element (k′, l′) in a time domain in the CDM group λ.

22. The UE of claim 16, wherein the mapping pattern is based on a first table, the first table being:

| | CDM | | W_{f}(k′) | | | | Wₜ(l′) | |
|---|---|---|---|---|---|---|---|---|
| DMRS Port | Group λ | Δ | k′ = 0 | k′ = 1 | k′ = 2 | k′ = 3 | l′ = 0 | l′ = 1 |
| P0 | 0 | 0 | 1 | 1 | 1 | 1 | 1 | 1 |
| P0 + 1 | 0 | 0 | 1 | −1 | 1 | −1 | 1 | 1 |
| P0 + 2 | 1 | Z | 1 | 1 | 1 | 1 | 1 | 1 |
| P0 + 3 | 1 | Z | 1 | −1 | 1 | −1 | 1 | 1 |
| P0 + 4 | 2 | 2*Z | 1 | 1 | 1 | 1 | 1 | 1 |
| P0 + 5 | 2 | 2*Z | 1 | −1 | 1 | −1 | 1 | 1 |
| P0 + 6 | 0 | 0 | 1 | 1 | 1 | 1 | 1 | −1 |
| P0 + 7 | 0 | 0 | 1 | −1 | 1 | −1 | 1 | −1 |
| P0 + 8 | 1 | Z | 1 | 1 | 1 | 1 | 1 | −1 |
| P0 + 9 | 1 | Z | 1 | −1 | 1 | −1 | 1 | −1 |
| P0 + 10 | 2 | 2*Z | 1 | 1 | 1 | 1 | 1 | −1 |
| P0 + 11 | 2 | 2*Z | 1 | −1 | 1 | −1 | 1 | −1 |
| P0 + 12 | 0 | 0 | 1 | 1 | −1 | −1 | 1 | 1 |
| P0 + 13 | 0 | 0 | 1 | −1 | −1 | 1 | 1 | 1 |
| P0 + 14 | 1 | Z | 1 | 1 | −1 | −1 | 1 | 1 |
| P0 + 15 | 1 | Z | 1 | −1 | −1 | 1 | 1 | 1 |
| P0 + 16 | 2 | 2*Z | 1 | 1 | −1 | −1 | 1 | 1 |
| P0 + 17 | 2 | 2*Z | 1 | −1 | −1 | 1 | 1 | 1 |
| P0 + 18 | 0 | 0 | 1 | 1 | −1 | −1 | 1 | −1 |
| P0 + 19 | 0 | 0 | 1 | −1 | −1 | 1 | 1 | −1 |
| P0 + 20 | 1 | Z | 1 | 1 | −1 | −1 | 1 | −1 |
| P0 + 21 | 1 | Z | 1 | −1 | −1 | 1 | 1 | −1 |
| P0 + 22 | 2 | 2*Z | 1 | 1 | −1 | −1 | 1 | −1 |
| P0 + 23 | 2 | 2*Z | 1 | −1 | −1 | 1 | 1 | −1 |

and wherein Z is 2 and wherein:
Δ represents a distance in a unit of number of REs for a code division multiplexing (CDM) group λ,
W_{f}(k′) represents the FD-0004 applied on a resource element (k′, l′) in the frequency domain in the CDM group λ, and
Wₜ(l′) represents a length-2 time division OCC (TD-0002) applied on the resource element (k′, l′) in a time domain in the CDM group λ.

23. The method of claim 18, wherein the mapping pattern is based on a first table, the first table being:

| | CDM | | W_{f}(k′) | | | | Wₜ(l′) | |
|---|---|---|---|---|---|---|---|---|
| DMRS Port | Group λ | Δ | k′ = 0 | k′ = 1 | k′ = 2 | k′ = 3 | l′ = 0 | l′ = 1 |
| P0 | 0 | 0 | 1 | 1 | 1 | 1 | 1 | 1 |
| P0 + 1 | 0 | 0 | 1 | −1 | 1 | −1 | 1 | 1 |
| P0 + 2 | 1 | Z | 1 | 1 | 1 | 1 | 1 | 1 |
| P0 + 3 | 1 | Z | 1 | −1 | 1 | −1 | 1 | 1 |
| P0 + 4 | 0 | 0 | 1 | 1 | 1 | 1 | 1 | −1 |
| P0 + 5 | 0 | 0 | 1 | −1 | 1 | −1 | 1 | −1 |
| P0 + 6 | 1 | Z | 1 | 1 | 1 | 1 | 1 | −1 |
| P0 + 7 | 1 | Z | 1 | −1 | 1 | −1 | 1 | −1 |
| P0 + 8 | 0 | 0 | 1 | 1 | −1 | −1 | 1 | 1 |
| P0 + 9 | 0 | 0 | 1 | −1 | −1 | 1 | 1 | 1 |
| P0 + 10 | 1 | Z | 1 | 1 | −1 | −1 | 1 | 1 |
| P0 + 11 | 1 | Z | 1 | −1 | −1 | 1 | 1 | 1 |
| P0 + 12 | 0 | 0 | 1 | 1 | −1 | −1 | 1 | −1 |
| P0 + 13 | 0 | 0 | 1 | −1 | −1 | 1 | 1 | −1 |
| P0 + 14 | 1 | Z | 1 | 1 | −1 | −1 | 1 | −1 |
| P0 + 15 | 1 | Z | 1 | −1 | −1 | 1 | 1 | −1 |

and wherein Z is 1 and wherein:
Δ represents a distance in a unit of number of REs for a code division multiplexing (CDM) group λ,
W_{f}(k′) represents the FD-0004 applied on a resource element (k′, l′) in the frequency domain in the CDM group λ, and
Wₜ(l′) represents a length-2 time division OCC (TD-0002) applied on the resource element k′, l′) in a time domain in the CDM group λ.

24. The method of claim 18, wherein the mapping pattern is based on a first table, the first table being:

| | CDM | | W_{f}(k′) | | | | Wₜ(l′) | |
|---|---|---|---|---|---|---|---|---|
| DMRS Port | Group λ | Δ | k′ = 0 | k′ = 1 | k′ = 2 | k′ = 3 | l′ = 0 | l′ = 1 |
| P0 | 0 | 0 | 1 | 1 | 1 | 1 | 1 | 1 |
| P0 + 1 | 0 | 0 | 1 | −1 | 1 | −1 | 1 | 1 |
| P0 + 2 | 1 | Z | 1 | 1 | 1 | 1 | 1 | 1 |
| P0 + 3 | 1 | Z | 1 | −1 | 1 | −1 | 1 | 1 |
| P0 + 4 | 2 | 2*Z | 1 | 1 | 1 | 1 | 1 | 1 |
| P0 + 5 | 2 | 2*Z | 1 | −1 | 1 | −1 | 1 | 1 |
| P0 + 6 | 0 | 0 | 1 | 1 | 1 | 1 | 1 | −1 |
| P0 + 7 | 0 | 0 | 1 | −1 | 1 | −1 | 1 | −1 |
| P0 + 8 | 1 | Z | 1 | 1 | 1 | 1 | 1 | −1 |
| P0 + 9 | 1 | Z | 1 | −1 | 1 | −1 | 1 | −1 |
| P0 + 10 | 2 | 2*Z | 1 | 1 | 1 | 1 | 1 | −1 |
| P0 + 11 | 2 | 2*Z | 1 | −1 | 1 | −1 | 1 | −1 |
| P0 + 12 | 0 | 0 | 1 | 1 | −1 | −1 | 1 | 1 |
| P0 + 13 | 0 | 0 | 1 | −1 | −1 | 1 | 1 | 1 |
| P0 + 14 | 1 | Z | 1 | 1 | −1 | −1 | 1 | 1 |
| P0 + 15 | 1 | Z | 1 | −1 | −1 | 1 | 1 | 1 |
| P0 + 16 | 2 | 2*Z | 1 | 1 | −1 | −1 | 1 | 1 |
| P0 + 17 | 2 | 2*Z | 1 | −1 | −1 | 1 | 1 | 1 |
| P0 + 18 | 0 | 0 | 1 | 1 | −1 | −1 | 1 | −1 |
| P0 + 19 | 0 | 0 | 1 | −1 | −1 | 1 | 1 | −1 |
| P0 + 20 | 1 | Z | 1 | 1 | −1 | −1 | 1 | −1 |
| P0 + 21 | 1 | Z | 1 | −1 | −1 | 1 | 1 | −1 |
| P0 + 22 | 2 | 2*Z | 1 | 1 | −1 | −1 | 1 | −1 |
| P0 + 23 | 2 | 2*Z | 1 | −1 | −1 | 1 | 1 | −1 |

and wherein Z is 2 and wherein:
Δ represents a distance in a unit of number of REs for a code division multiplexing (CDM) group λ,
W_{f}(k′) represents the FD-0004 applied on a resource element (k′, l′) in the frequency domain in the CDM group λ, and
Wₜ(l′) represents a length-2 time division OCC (TD-0002) applied on the resource element (k′, l′) in a time domain in the CDM group λ.
